(19) United States
(12) Patent Application Publication
(10) Pub. No.: US 2024/0086854 A1
(43) Pub. Date: Mar. 14, 2024

(54) SUBSCRIPTION-BASED METHOD FOR PROVIDING CAREER SEARCHING AND RECRUITMENT SERVICES FOR SKILLED TRADES

(71) Applicant: Nicole Bass, Reston, VA (US)

(72) Inventor: Nicole Bass, Reston, VA (US)

(21) Appl. No.: 18/465,587

(22) Filed: Sep. 12, 2023

Related U.S. Application Data
(60) Provisional application No. 63/375,296, filed on Sep. 12, 2022.

(51) Int. Cl. G06Q 10/1053; G06Q 10/0631

(52) U.S. Cl. CPC G06Q 10/1053; G06Q 10/063112

(57) ABSTRACT

A subscription-based method for providing career searching services and recruitment services as they may relate to skilled trades is provided. The present invention provides a passive-recruitment system user interface of multiple trades funded through employer and trade school subscriptions. Career-seekers can search for opportunities in their area as well as through other selectable criteria. The present invention is also configured to list on the user interface career opportunities highlighting employer value propositions including earning data based on years of experience and responsibilities associated with a position, while excluding employer job posts from the user interface.

### CROSS-REFERENCE TO RELATED APPLICATION

This application claims the benefit of priority of U.S. provisional application No. 63/375,296, filed Sep. 12, 2022, the contents of which are herein incorporated by reference.

### BACKGROUND OF THE INVENTION

The present invention relates to methods for providing job searching services and recruitment services and, more particularly, a subscription-based method for providing career searching services and recruitment services as they may relate to skilled trades.

Although careers in skilled trades offer high earning potential and tradesperson are in high demand, those seeking a career in a skilled trade rarely know how to get started in such a career. A tradesperson is a skilled worker that specializes in a particular trade. Tradespeople usually gain their skills through work experience, on-the-job training, an apprenticeship program, or formal education. Some of them produced goods that they sold from their own premises (e.g., bootmakers, saddlers, hatmakers, jewelers, glassblowers); others (e.g., typesetters, bookbinders, wheelwrights) were employed to do one part of the production in a business that required a variety of skilled workers. Still others were factory hands who had become experts in some complex part of the process and could command high wages and steady employment. Skilled workers in the building trades (e.g., carpenters, masons, plumbers, painters, plasterers, glaziers) were also referred to by one or another of these terms.

On the flipside, employers of tradespersons are willing to pay for those starting out in a skilled trade to attend formal training in addition to offering a paycheck, yet employers do not know how to promote that offering to recruit more people into the skilled trades they need.

Traditionally, trades careers begin by speaking with a local trade school or through word of mouth. Many current online platforms geared toward those seeking a career in a skilled trade are either (1) informational in nature and are limited to a certain geographical zone or trades or (2) merely a standard job board. Standard job boards used by employers are time consuming to maintain and are not geared to effectively promote the company behind the offered position. One solution that the inventor is aware of is BlueRecruit.com; however, this site attempts to only create a database of skilled workers who can then be sourced by employers.

Furthermore, current analog and online solutions both suffer from inaccuracies in determining and reporting earning data for skilled tradesperson careers. In the online space, this inaccuracy is a product of models designed for corporate or non-trades careers. This has resulted in a well-documented gap in skilled labor which impacts all trades industries. For instance, traditional job sites include job posts and uploaded resumes or applications, by employers and employees, respectively, allowing candidates to search for jobs; however, these job posts merely aggregate earnings data based only on job title to create inaccurate ‘average earning potential’. Aggregating earning potential based on ‘job title’ presents an inaccurate depiction of earning potential in the skilled trades space, as job titles for skilled trades are not based on experience or level of responsibility as they are in corporate careers.

Moreover, the analog and online solutions do not educate users on careers/industries underlying the posted jobs. Online solutions for skilled tradespeople do not have standardized fields to allow like-for-like comparisons from one job to the next (i.e., benefits, perks).

As can be seen, there is a need for a subscription-based method for providing career searching services and recruitment services as they may relate to skilled trades.

### SUMMARY OF THE INVENTION

The information a career-seeker can get on a particular trade is limited in the prior art. The present invention (colloquially known as “JoinTheTrades.com”) may include a trade education module providing information underlying each posted employer search. The information may include what ‘A Day in the Life’ consists of, what the average pay scales are, and what specific opportunities are available in their geographic area. Thereby, the present invention provides career information for someone interested in exploring their college alternatives, not just a job post. Users of the computer implemented method embodied in the present invention will learn about various trades as they look for opportunities in their trades of interest. This ‘passive recruiting’ model embodied by the present invention takes the work out of the hands of the employers and provides more thorough information for career-seekers.

The present invention will provide a comprehensive database of multiple trades and will be funded through employer and trade school subscriptions. Career-seekers can search for opportunities in their area and contact the appropriate employers or trade schools, depending on where users find themselves after accessing the trade education module. The present invention is also configured to highlight employer value propositions by accounting for more than just the resulting paycheck. The employer value proposition will consider employer-paid training and other perks. The present invention will focus more on the database of employers to allow for passive recruiting efforts.

The present invention allows users to filter employer value propositions based on experience and preferences, from there directing the user to specific employers or trade school that will enhance the user's long-term earning potential. To that end, earning data is organized and displayed by years of experience and responsibilities rather than job titles to provide accurate information and attract more people into the skilled trades.

The present invention leverages extensive search and filter criteria to match candidates with their start in the skilled trades, after educating them on careers in those trades. The standardized profile fields for career seekers, employers and schools allows for accurate comparisons of employment and schooling opportunities, thereby offering users an informed decision-making process and outcome.

In short, the present invention will provide a comprehensive database of employers and trade schools who offer an opportunity to join the trades in either a pay-to-learn or earn-and-learn format. The present invention embodies a comprehensive platform designed to educate individuals about careers in the skilled trades and offer multiple pathways to enter those trades within a specific geographic area. The platform aims to benefit employers, schools, unions, and career seekers.

For employers, schools, and unions, the present invention offers passive recruiting opportunities so that organizations can showcase their trade-related programs, job openings, and apprenticeship opportunities on the platform. By doing so, they can attract individuals who are actively seeking information about and opportunities in the skilled trades.

Career seekers, on the other hand, can benefit from the present invention in several ways. The platform provides them with detailed information about various skilled trades careers, helping them make informed decisions about their career paths. It offers insights into the skills required, training programs available, and potential job opportunities in their chosen trades.

Additionally, the present invention facilitates immediate connections for career seekers. Whether they prefer to pursue a trade through direct employment, formal education at a school, or joining a union, the platform helps connect them with relevant resources and contacts. This approach provides individuals with multiple routes to get started in their chosen trade, catering to their specific preferences and circumstances.

Overall, the present invention aims to bridge the gap between career seekers and organizations within the skilled trades industry. By providing comprehensive information, facilitating connections, and offering various entry pathways, the platform strives to create a more accessible and informed environment for those interested in pursuing a career in the skilled trades.

In one aspect of the present invention, a method includes the following: identifying a set of career opportunities based on a comparison of attributes of the career opportunities with career interest criteria specified by a candidate; providing foundational information associated with each career opportunity through a career education module; assessing the career interest criteria subsequent to providing the foundational information, obtaining an assessment result for each career opportunity; and outputting recommendations by applying the assessment result to each career opportunity.

In another aspect of the present invention, the method further includes wherein identifying the set of career opportunities includes filtering, a plurality of career opportunities based their status as an employer search and a school/union search, and wherein assessing the career interest criteria includes providing earning data based on years of experience in an employment associated with the employer search and years of experience in training associated with the school/union search.

In yet another aspect of the present invention, the method includes identifying a set of career opportunities based on a comparison of attributes of the career opportunities with career interest criteria specified by a candidate; providing foundational information associated with each career opportunity through a career education module; assessing the career interest criteria after providing the foundational information, obtaining an assessment result for each career opportunity based on input by the candidate in response to the foundational information; and outputting recommendations by applying the assessment result to each career opportunity, wherein each recommendation includes a value proposition, and wherein the value proposition comprises an earning data based on years of experience in the career opportunity, whereby each career opportunity excludes job posts by employers of the career opportunity, wherein the earning data is based on level of responsibility in the career opportunity, wherein identifying the set of career opportunities includes filtering based on physical demand, wherein identifying the set of career opportunities includes filtering based on a requirement of math skills, and wherein identifying the set of career opportunities includes filtering based on a proximity relative to an identified location.

These and other features, aspects and advantages of the present invention will become better understood with reference to the following drawings, description, and claims.

### BRIEF DESCRIPTION OF THE DRAWINGS

FIG. 1 is a block diagram of a home page of an exemplary embodiment of the present invention.

FIG. 2 is a block diagram of the home page, post login, of an exemplary embodiment of the present invention.

FIG. 3 is a block diagram of filter criteria functionality enabled by an exemplary embodiment of the present invention.

FIG. 4 is a block diagram of a general and/or special purpose computer 500, which may be a general and/or special purpose computing device, in accordance with some of the example embodiments of the invention. The computer 500 may be, for example, a user device, a user computer, a client computer and/or a server computer, among other things.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a subscription-based method for providing career searching services and recruitment services as they may relate to skilled trades.

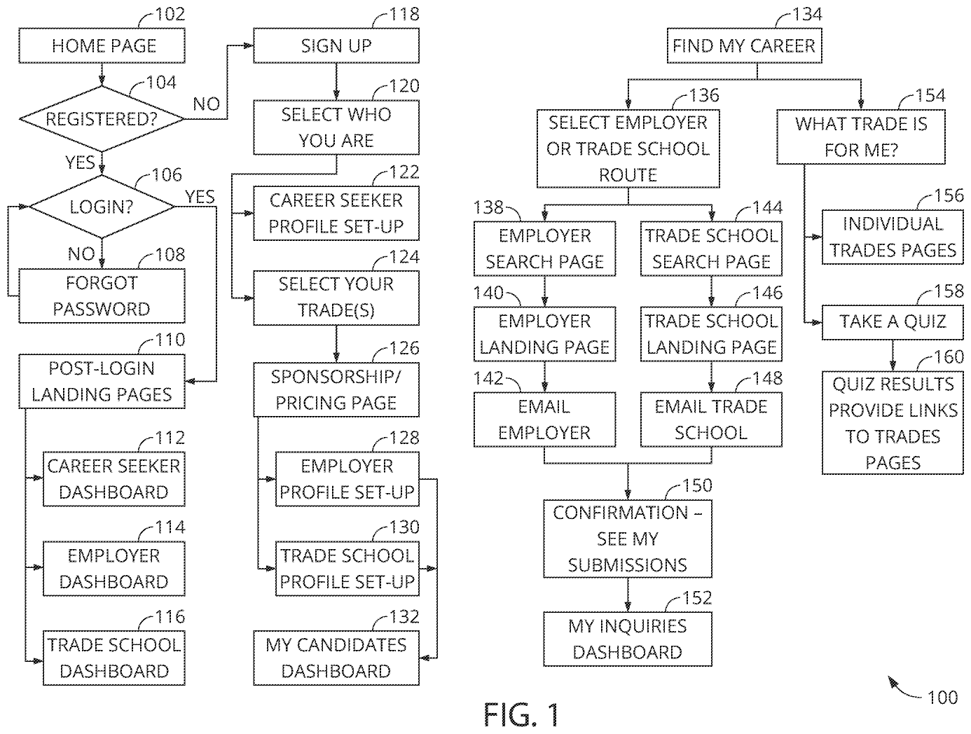

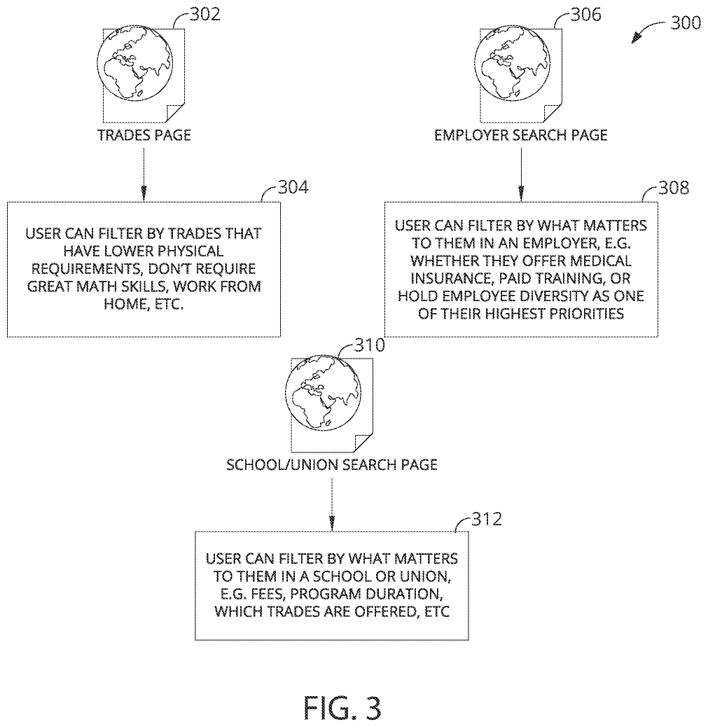

Referring now to FIGS. 1 through 4, the present invention may include the following systemic components: a web application module; an employer search module 306; a trade school/union search module 310; a trade educational page module 302; and a trade placement assessment module. The trade educational page module 302 enables functionality to filter by trades based on criteria such as, but not limited to, strength requirements, proficiency in mathematics, and work-for-home possibilities, and the like. The employer search module 306 enables functionality to filter prospective employers based on criteria such as, but not limited to, insurance provided, paid training provided, diversity, and the like. The trade school/union search module 310 enables functionality to filter by requirements of trade schools and trade unions such as, but not limited to, fees, program duration, and the like.

The web application module (which will sync with a mobile app) may provide a comprehensive platform of resources for employers, trade schools and career seekers leveraged by the employer search module 306, the trade school/union search module 310, and the trade educational page module 302.

The assessment will provide career-seekers with a simple assessment to see which trade is the best fit for them.

If the career seeker wants to connect with a trade school or employer, they must complete their own profile first by going through the home page of the systemic platform. Profiles are free for career seekers. Once complete, they can request an interview from an employer or trade school through interfacing with a computer algorithm 100, thereby implementing the trade placement assessment module.

Referring to FIG. 1, the computer algorithm 100 is configured to proceed to relevant trade placement assessment processes that are like the processes to be described in blocks 102-160.

At block 102, the computer algorithm 100 creates a home page.

At block 104, the computer algorithm 100 prompts a user for registration.

At block 106, the computer algorithm 100 enables login.

At block 108, the computer algorithm 100 creates a password prompt.

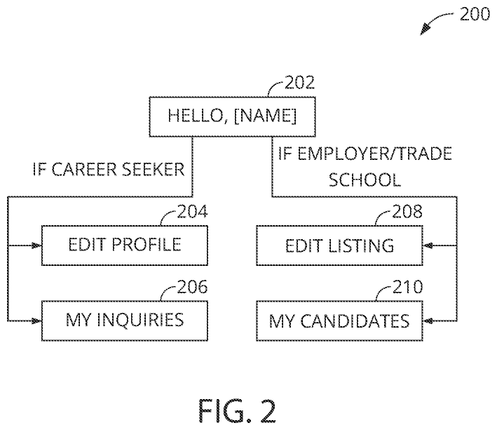

At block 110, the computer algorithm 100 generates a post login landing page, as illustrated in FIG. 2.

At block 112, the computer algorithm 100 generates an employer dashboard.

At block 114, the computer algorithm 100 generates a career-seeker dashboard.

At block 116, the computer algorithm 100 generates a trade-school dashboard.

At block 118, the computer algorithm 100 creates a sign-up interface.

At block 120, the computer algorithm 100 creates a user-selection interface.

At block 122, the computer algorithm 100 creates a career-seeker profile setup interface.

At block 124, the computer algorithm 100 prompts a trade selection.

At block 126, the computer algorithm 100 creates a sponsorship/pricing page.

At block 128, the computer algorithm 100 creates an employer profile setup interface.

At block 130, the computer algorithm 100 creates a trade school profile setup interface.

At block 132, the computer algorithm 100 generates a candidate dashboard.

At block 134, the computer algorithm 100 a generates a find my career page.

At block 136, the computer algorithm 100 creates a select employer or trade school route page.

At block 138, the computer algorithm 100 creates an employer search page.

At block 140, the computer algorithm 100 creates an employer landing page.

At block 142, the computer algorithm 100 creates an employer email page.

At block 144, the computer algorithm 100 creates a trade school search page.

At block 146, the computer algorithm 100 creates a trade school landing page.

At block 148, the computer algorithm 100 creates an email trade school page.

At block 150, the computer algorithm 100 creates a confirmation—see my submissions page.

At block 152, the computer algorithm 100 creates a my inquiries dashboard.

At block 154, the computer algorithm 100 creates a what trade is for me page.

At block 156, the computer algorithm 100 creates an individual trades page.

At block 158, the computer algorithm 100 creates a take a quiz page.

At block 160, the computer algorithm 100 creates a quiz result provide links to trades pages.

The employer and trade school search pages will provide job seekers with the ability to find and refine opportunities in their area. The educational pages will educate career-seekers on what each trade entails.

An employer trade school may create a profile for a monthly subscription. Once they create a profile, they will be searchable by career-seekers. How they complete their profile will determine in which search filters their company or school is represented.

Career-seekers may visit the website and—if needed—read about the various trade opportunities available. They can also take an assessment to see what trade is the best fit for them. They can then go to the search pages and see what opportunities are available in their area. If they find an opportunity that interests them, they can then create their own profile and submit their information to that company or school. Career seeker profiles are free. If their profiles indicate they do not have the level experience that the employer is currently hiring, they will not be permitted to submit their information to that employer.

When they submit their information to the school or employer, the school or employer will receive an email with the career seeker's information, to include level of experience and job history. If there's a good fit, they have the option of contacting the jobseeker.

Job seekers, employers and trade schools will all have a dashboard they can visit to see all submissions and contact information.

Users will also have the option of taking an assessment to see which trade(s) are the best fit for them through the trade placement assessment module, which is configured to ask a series of questions of the jobseeker, and depending on how they respond to each question, the program will recommend trade opportunities that may be a good fit.

The search pages similarly employ logic for making decisions based on geographic territory, trade type, value proposition, experience level, and other variables to allow a career-seeker and employer or trade school the best match. For example, if a career seeker only wants to see full-time opportunities within ten miles of their house, that offer family medical benefits, all employers who do not meet this criterion will be excluded from their search results.

### Configuring the Present Invention

In certain embodiments, the development stack as it is currently planned may include the following:

### Codebase:

JAVA: 17 (Latest)
PHP: 8.0.19 (Latest)
CSS: 4.15 (Latest)
HTML5: (Latest)

### Storage:

S3: Amazon AWS or other on-demand cloud computing platforms.
RDS: MySQL 8.0.28 (×2) or other distributed relational database service.

### Routing:

Route 53: AWS or other scalable Domain Name System (DNS) web service.

### Encryption Methods:

SSL/TLS or equivalent secure sockets layer and transport layer security protocol or communication rule that allows computer systems to talk to each other on the internet safely and to identify and establish encrypted network connections to web sites.
Hash: sha3-512 and/or Cipher: aes-128-gcm (PHP) or other processes of encoding information.

### Deployment:

VS CODE
GitHub
AWS CodeDeploy
AWS EC2
AWS Elastic beanstalk II LightSail
Branch (Master/Dev/QA/Production)

API:

Google Maps API or other software interfaces that enable two or more computer programs to communicate with each other and offering a service to other pieces of software.

A method of using the present invention may include the following: employers or trade schools will subscribe based on their trade and geographic region. They will agree to a monthly fee for each trade they offer in each geographic region. Then they will be prompted to complete their profile which will include a series of questions such as “what years of experience are you hiring/do you train” with a dropdown list of options. They will also have a small field of text to describe their company. They can also upload a logo.

Schools and unions highlight the programs they offer. They can make their listing active or hide it depending on whether they are recruiting at the time. They define the minimum requirements to be contacted to prevent unqualified candidates from connecting.

Referring to the post-login interface 200 of FIG. 2, a user may be a career seeker or an employer/trade school. For the former, career-seekers may be prompted to edit their profile, at block 204, and make inquiries, at block 206, each prompted by the computer system/computer algorithm. The employer or trade school, at block 208 may be prompted to edit listings and, at block 210, configure their candidates. The employer or trade school will receive an email with the career-seeker's information and experience. They have the option of contacting them if they want.

Career seekers use the invention in several ways. They can take an assessment to see which skilled trades careers would be a good fit for them. They can search and filter opportunities with employers, schools and unions by location, requirements, and qualities/preferences. They can create a single profile of their contact information, work history, education history, languages, skills and more to send to local employers, schools, and unions to request an interview. Career-seekers, employers and trade schools can login to the web app at any time to see their dashboard of connection requests or connections requested.

Career seekers will visit the site and can browse without creating a profile. They can read about the various trades to include: 1) What it is 2) A Day in the Life 3) Average Pay by Level of Experience 4) Pros/Cons 5) Fitness through accessing the trade educational page module 302.

Career seekers can also go to a search page for employers in their area or for trade schools in their area through the employer search module 306. They can filter by various values like experience level required, geographic region, years in business, full-time or part-time roles, paid education, specific trade, and value proposition.

The present invention may include a Trades Page, wherein a user can filter all trades careers by the following non-exhaustive list:
Category
   Agriculture
   Aviation
   Construction
   Cosmetology
   Culinary Arts
   Healthcare
   Information Technology
   Landscaping
   Maintenance and Repair
   Marine
   Service
   Trades and Manufacturing
   Transportation
Good math skills required (yes/no)
Long term high demand (yes/no)
Lower physical demand (yes/no)
Work from home

The results will display the various trade careers which meet the user's criteria. The user can then click into each trade to learn more, and/or search by zip code for employers, trade schools or unions for that trade and filter to further narrow their search.

By way of the Employer Search Page (306) a user can browse a list of employers by zip code and/or they can filter by certain criteria shown below, which will narrow their search to only the employers who meet the refined criteria.
Distance (to zip code entered)—measured as a radius around the zip code using longitude and latitude.
   Within 5 miles
   Within 10 miles
   Within 25 miles
   Within 50 miles
   Within 100 miles
Work type
   Full Time
   Part Time
   Internships
   Seasonal
   Second Chance Employers
Trades
   List of all skilled trades careers on site
Perks
   Disability insurance
   Education assistance
   Employee assistance programs
   Employee discounts
   Employee referral programs
   Employee stock purchase plans
   Employee wellness programs
   Flexible work arrangements
   Life insurance
   Medical benefits for employee
   Medical benefits for family
   Paid time off
   Parental leave
   Pension
   Retirement savings plan
   Training & professional development
   Transportation benefits
Experience Level
   0-1 Year
   2-4 Years
   5-9 Years
   10+ Years
Value Proposition
   Competitive Compensation & Benefits
   Diverse & Inclusive Workforce
   Employee Professional Development Programs
   Family Owned & Operated
   Good Work-Life Balance
   Interesting & Innovative Projects
   Multiple Career Advancement Opportunities
   High Employee Tenure
   Strong Reputation or Brand

With their narrowed selection, the user can then explore the narrowed list of employers and click to learn more about each employer. They can then contact the employer to request an interview.

The present invention may include a School/Union Search Page (310) Users can browse a list of schools and unions by zip code and/or they can filter by certain criteria (non-exhaustively) listed below, which will narrow their search to only the schools/unions who meet the refined criteria.
Distance (to zip code entered)—measured as a radius around the zip code using longitude and latitude.
   Within 5 miles
   Within 10 miles
   Within 25 miles
   Within 50 miles
   Within 100 miles
Trades
   List of all trades careers on site
Learning format
   In Person
   In Person and Online
   Online
Organization
   School
   Union
Program Duration
   0-1 Year
   2-4 Years
   5-9 Years
   10+ Years
Program Cost
   <$1,000
   $1,000-$3,000
   $3,001-$5,000
   $5,001-10,000
   $10,000-$20,000
   $20,000+

Also, the present invention can facilitate a depository a national/regional average of salaries for each of the trades by year of experience, providing for more accurate publication of the earning opportunity for the trades, rather than producing an average that is not based on years of experience. This (accurate) data is not currently publicly available. The inventor believes the present invention will assist with bridging the skilled labor gap which causes infrastructure and economic problems in the United States.

Additionally, the method and structure of the site could be used in careers that do not fall into the category of the skilled trades. For instance, the present invention may be configured so that the ‘skilled trades’ are defined as any career that requires a skill which cannot be taught by a 4-year university degree. This includes construction trades such as carpentry, plumbing and electrical as well as other skills such as hair stylist, firefighter, software coding and more.

The computer 500 may include without limitation a processor device 530, a main memory 535, and an interconnect bus 537. The processor device 530 may include without limitation a single microprocessor or may include a plurality of microprocessors for configuring the computer 500 as a multi-processor system. The main memory 535 stores, among other things, instructions and/or data for execution by the processor device 530. The main memory 535 may include banks of dynamic random-access memory (DRAM), as well as cache memory.

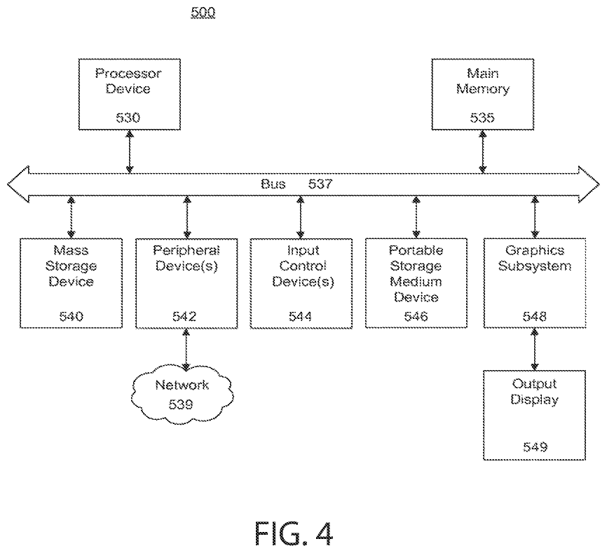

Referring to FIG. 4, a computer 500 utilized to access the present invention may include a mass storage device 540, peripheral device(s) 542, non-transitory storage medium device(s) 546, input control device(s) 544, a graphics subsystem 548, and/or a display 549. For explanatory purposes, all components in the computer 500 are shown in FIG. 4 as being coupled through the bus 537. However, the computer 500 is not so limited. Devices of the computer 500 may be coupled through one or more data transport means. For example, the processor device 530 and/or the main memory 535 may be coupled through a local microprocessor bus. The mass storage device 540, peripheral device(s) 542, portable storage medium device(s) 546, and/or graphics subsystem 548 may be coupled via one or more input/output (I/O) buses. The mass storage device 540 may be a nonvolatile storage device for storing data and/or instructions for use by the processor device 530. The mass storage device 540 may be implemented, for example, with a magnetic disk drive or an optical disk drive. In a software embodiment, the mass storage device 540 is configured for loading contents of the mass storage device 540 into the main memory 535.

The portable storage medium device 546 operates in conjunction with a nonvolatile portable storage medium, such as, for example, a compact disc read only memory (CD-ROM), to input and output data and code to and from the computer 500. In some embodiments, the software for storing information may be stored on a portable storage medium, and may be inputted into the computer 500 via the portable storage medium device 546. The peripheral device(s) 542 may include any type of computer support device, such as, for example, an input/output (I/O) interface configured to add additional functionality to the computer 500. For example, the peripheral device(s) 542 may include a network interface card for interfacing the computer 500 with a network 439.

The input control device(s) 544 provide a portion of the user interface for a user of the computer 500. The input control device(s) 544 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 500 may include the graphics subsystem 548 and the output display 549. The output display 549 may include a cathode ray tube (CRT) display and/or a liquid crystal display (LCD). The graphics subsystem 548 receives textual and graphical information, and processes the information for output to the output display 549.

Each component of the computer 500 may represent a broad category of a computer component of a general and/or special purpose computer. Components of the computer 500 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

In certain embodiments, a network of the present invention may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In some embodiments, the computing systems includes a processor, a memory, a user interface and a communication interface. In some embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to a computing system, where appropriate. In some embodiments the memory is non-volatile, solid-state memory.

The user interface includes hardware, software, or both providing one or more interfaces for communication between a person and the computer systems. As an example, and not by way of limitation, an user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the present invention.

It should be understood, of course, that the foregoing relates to exemplary embodiments of the invention and that modifications may be made without departing from the spirit and scope of the invention as set forth in the following claims.

What is claimed is:

1. A method, comprising:
identifying a set of career opportunities based on a comparison of attributes of the career opportunities with career interest criteria specified by a candidate;
providing foundational information associated with each career opportunity through a career education module;
assessing the career interest criteria after providing the foundational information, obtaining an assessment result for each career opportunity based on input by the candidate in response to the foundational information; and
outputting recommendations by applying the assessment result to each career opportunity, wherein each recommendation includes a value proposition, and wherein the value proposition comprises an earning data based on years of experience in the career opportunity,
whereby each career opportunity excludes job posts by employers of the career opportunity.

2. The method of claim 1, wherein the earning data is based on level of responsibility in the career opportunity.

3. The method of claim 1, wherein identifying the set of career opportunities includes filtering based on physical demand.

4. The method of claim 1, wherein identifying the set of career opportunities includes filtering based on a requirement of math skills.

5. The method of claim 1, wherein identifying the set of career opportunities includes filtering based on a proximity relative to an identified location.
